(19) United States
(12) Patent Application Publication
(10) Pub. No.: US 2025/0322504 A1
(43) Pub. Date: Oct. 16, 2025

(54) INFORMATION PROCESSING DEVICE, AND DETECTION METHOD

(71) Applicant: Mitsubishi Electric Corporation, Tokyo (JP)

(72) Inventors: Eri MORIYA, Tokyo (JP); Takafumi KOIKE, Tokyo (JP)

(73) Assignee: Mitsubishi Electric Corporation, Tokyo (JP)

(21) Appl. No.: 19/246,627

(22) Filed: Jun. 23, 2025

Related U.S. Application Data
(63) Continuation of application No. PCT/JP2023/005707, filed on Feb. 17, 2023.

(51) Int. Cl. G06T 7/00; G06T 7/10

(52) U.S. Cl. CPC G06T 7/0002; G06T 7/10; G06T 2207/20021

(57) ABSTRACT

An information processing device includes an acquisition unit that acquires an image of a stranded wire, a division unit that divides the image of the stranded wire, a calculation unit that calculates a plurality of similarity levels by using a plurality of object images set out of a plurality of images obtained by the division and a plurality of comparative images set out of the plurality of images, normalizes the plurality of similarity levels, calculates a class classification threshold value by using a plurality of values obtained by the normalization, calculates one value in regard to each class based on the class classification threshold value, and calculates a difference between the calculated two values as an inter-class distance, and a determination unit that determines that the stranded wire is abnormal when the inter-class distance is greater than or equal to a predetermined first threshold value.

### CROSS-REFERENCE TO RELATED APPLICATION

This application is a continuation application of International Application No. PCT/JP2023/005707 having an international filing date of Feb. 17, 2023, which is hereby expressly incorporated by reference into the present application.

### BACKGROUND OF THE INVENTION

### 1. Field of the Invention

The present disclosure relates to an information processing device, and a detection method.

### 2. Description of the Related Art

Stranded wires are used. For example, stranded wires are used for an electric cable. Here, a technology for detecting an abnormality by using a mean luminance value of an image has been proposed (see Patent Reference 1).

Patent Reference 1: Japanese Patent Application Publication No. HEI10-117415

Additionally, it is possible to consider a method of inspecting a stranded wire by using the mean luminance value of an image. However, with this method, accuracy of the abnormality detection is low.

### SUMMARY OF THE INVENTION

An object of the present disclosure is to detect an abnormality with high accuracy.

An information processing device according to an aspect of the present disclosure is provided. The information processing device includes an acquisition unit that acquires an image of a stranded wire, a division unit that divides the image of the stranded wire, a calculation unit that calculates a plurality of similarity levels by using a plurality of object images set out of a plurality of images obtained by the division and a plurality of comparative images set out of the plurality of images, normalizes the plurality of similarity levels, calculates a class classification threshold value by using a plurality of values obtained by the normalization, calculates one value in regard to each class obtained by classification of the plurality of values based on the class classification threshold value, and calculates a difference between the calculated two values as an inter-class distance, and a determination unit that determines that the stranded wire is abnormal when the inter-class distance is greater than or equal to a predetermined first threshold value.

According to the present disclosure, an abnormality can be detected with high accuracy.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device in a first embodiment;

FIG. 2 is a block diagram showing functions of the information processing device in the first embodiment;

FIG. 3 is a diagram showing an example of a process of calculating a plurality of similarity levels in the first embodiment;

FIG. 4 is a diagram showing an example of normalization in the first embodiment;

FIG. 5 is a diagram showing an example of calculation of a class classification threshold value in the first embodiment;

FIG. 6 is a flowchart showing an example (part 1) of a process executed by the information processing device in the first embodiment;

FIG. 7 is a flowchart showing the example (part 2) of the process executed by the information processing device in the first embodiment;

FIG. 8 is a block diagram showing functions of an information processing device in a second embodiment;

FIG. 9 is a flowchart showing an example of a process executed by the information processing device in the second embodiment;

FIG. 10 is a diagram showing a general outline of a process executed by an information processing device in a third embodiment;

FIG. 11 is a flowchart showing an example (part 1) of the process executed by the information processing device in the third embodiment;

FIG. 12 is a flowchart showing the example (part 2) of the process executed by the information processing device in the third embodiment;

FIG. 13 is a flowchart showing an example of a process executed by an information processing device in a fourth embodiment; and

FIG. 14 is a flowchart showing an example of a process executed by an information processing device in a modification of the fourth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

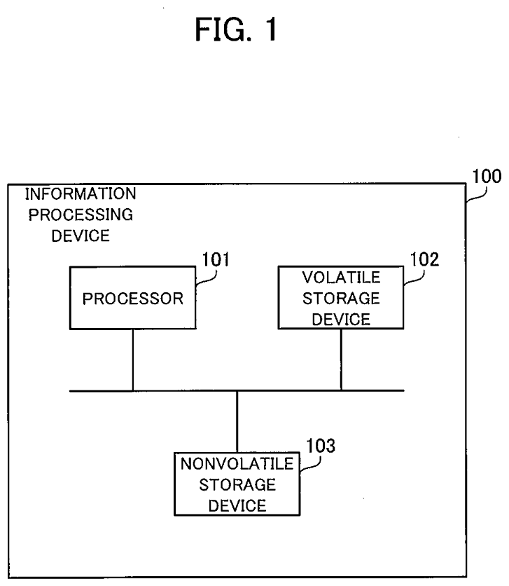

FIG. 1 is a diagram showing hardware included in an information processing device in a first embodiment. The information processing device 100 is a device that executes a detection method. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions of the information processing device 100 will be described below.

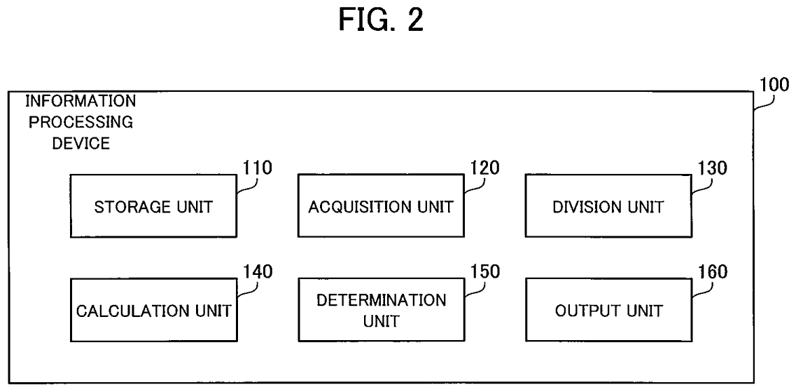

FIG. 2 is a block diagram showing the functions of the information processing device in the first embodiment. The information processing device 100 includes a storage unit 110, an acquisition unit 120, a division unit 130, a calculation unit 140, a determination unit 150 and an output unit 160.

The storage unit 110 may be implemented as a storage area reserved in the volatile storage device 102 or the nonvolatile storage device 103.

Part or all of the acquisition unit 120, the division unit 130, the calculation unit 140, the determination unit 150 and the output unit 160 may be implemented by processing circuitry. Further, part or all of the acquisition unit 120, the division unit 130, the calculation unit 140, the determination unit 150 and the output unit 160 may be implemented as modules of a program executed by the processor 101. For example, the program executed by the processor 101 is referred to also as a detection program. The detection program has been recorded in a record medium, for example.

The storage unit 110 stores a variety of information.

The acquisition unit 120 may acquire an image including a stranded wire. For example, the acquisition unit 120 acquires the image from the storage unit 110. Further, for example, the acquisition unit 120 acquires the image from a camera. Furthermore, for example, the acquisition unit 120 acquires the image from an external device. Incidentally, the external device is a cloud server, for example. Illustration of the external device is left out.

Further, the stranded wire is, for example, an electric wire, a wire supporting a utility pole, a wire supporting a bridge, or the like.

The acquisition unit 120 may acquire an extracted image of the stranded wire from the image including the stranded wire. In other words, the acquisition unit 120 may acquire an extracted image region of the stranded wire from the image including the stranded wire. Incidentally, the extraction process may be executed by the information processing device 100.

The acquisition unit 120 acquires an image of the stranded wire. As mentioned above, the acquisition unit 120 may acquire an extracted image of the stranded wire. Further, the acquisition unit 120 may acquire the image of the stranded wire from the storage unit 110 or an external device.

The division unit 130 divides the image of the stranded wire. Specifically, the division unit 130 divides the image of the stranded wire into previously set lengths.

The calculation unit 140 calculates a plurality of similarity levels by using a plurality of object images set out of a plurality of images obtained by the division and a plurality of comparative images set out of the plurality of images. Here, the calculation of the plurality of similarity levels will be described below by using a concrete example.

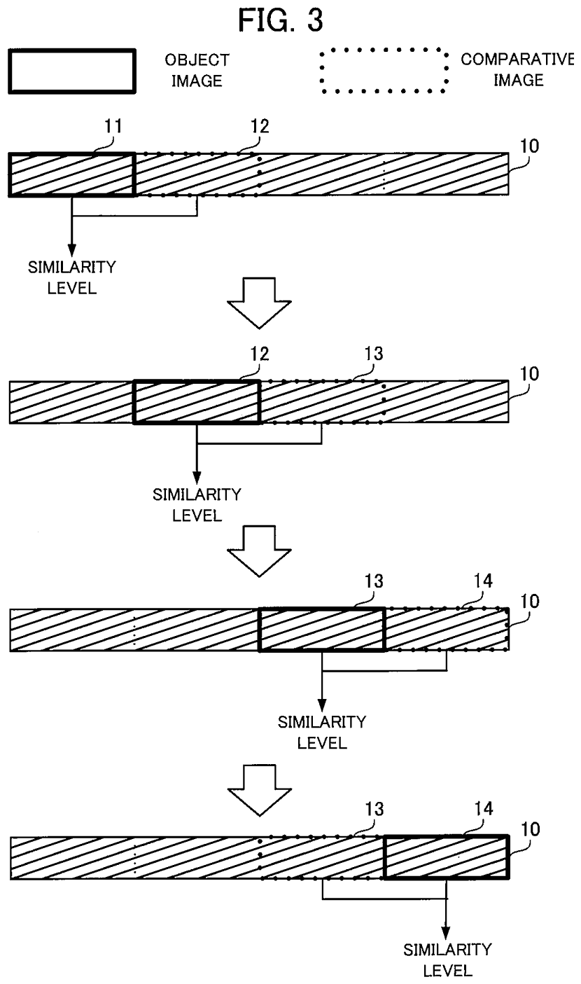

FIG. 3 is a diagram showing an example of a process of calculating the plurality of similarity levels in the first embodiment. FIG. 3 shows an image 10 of the stranded wire. The division unit 130 divides the image 10 into four.

The calculation unit 140 sets an image 11 as the object image out of the plurality of images obtained by the division. The calculation unit 140 sets an image 12 as the comparative image out of the plurality of images. The calculation unit 140 calculates the similarity level of the image 11 and the image 12 by using technology of template matching. Incidentally, the template matching is performed by use of normalized cross-correlation, Sum of Squared Difference (SSD) or the like, for example. Further, the similarity level may either represent the degree of similarity of two images or represent the degree of dissimilarity of two images.

The calculation unit 140 sets the image 12 as the object image out of the plurality of images obtained by the division. The calculation unit 140 sets an image 13 as the comparative image out of the plurality of images. The calculation unit 140 calculates the similarity level of the image 12 and the image 13.

The calculation unit 140 sets the image 13 as the object image out of the plurality of images obtained by the division. The calculation unit 140 sets an image 14 as the comparative image out of the plurality of images. The calculation unit 140 calculates the similarity level of the image 13 and the image 14.

The calculation unit 140 sets the image 14 as the object image out of the plurality of images obtained by the division. The calculation unit 140 sets the image 13 as the comparative image out of the plurality of images. The calculation unit 140 calculates the similarity level of the image 13 and the image 14.

As above, the calculation unit 140 calculates a plurality of similarity levels by using a plurality of object images set out of the plurality of images obtained by the division and a plurality of comparative images set out of the plurality of images.

FIG. 3 has indicated a case where an image adjacent to the object image is set as the comparative image. The comparative image does not necessarily have to be an image adjacent to the object image. For example, the comparative image can also be the second image from the object image. Specifically, when the object image is the image 11, the comparative image can also be the image 13. Further, it is permissible even if a part of the comparative image and a part of the object image are the same, for example.

The calculation unit 140 normalizes the plurality of similarity levels. A concrete example of the normalization will be described below by using a drawing.

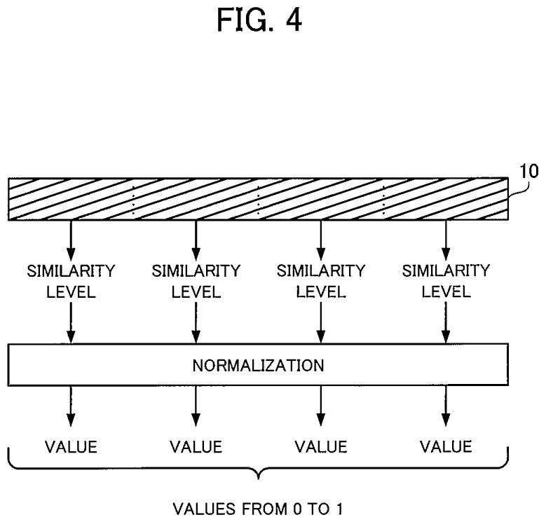

FIG. 4 is a diagram showing an example of the normalization in the first embodiment. The calculation unit 140 normalizes the plurality of similarity levels. For example, the calculation unit 140 normalizes the plurality of similarity levels to values obtained when the minimum value among the plurality of similarity levels is normalized to 0 and the maximum value among the plurality of similarity levels is normalized to 1. By this normalization, the plurality of similarity levels is converted to values from 0 to 1. That is, each of the converted values is expressed as “0≤value≤1”.

The calculation unit 140 calculates a class classification threshold value by using a plurality of values obtained by the normalization. The calculation of the class classification threshold value will be described below by using a drawing.

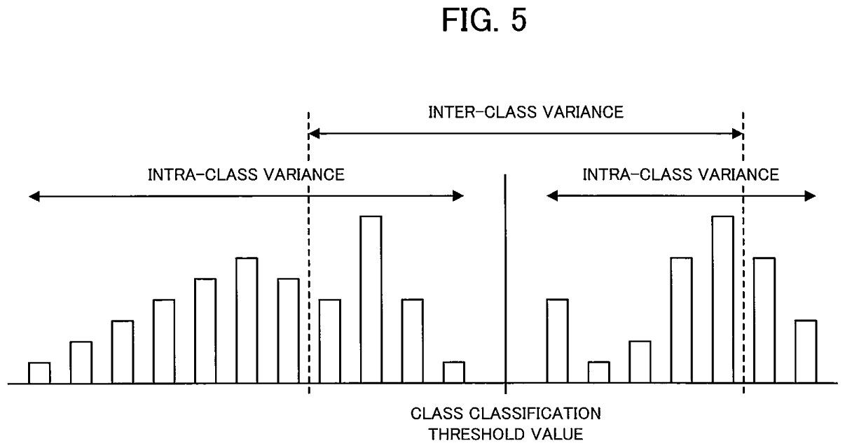

FIG. 5 is a diagram showing an example of the calculation of the class classification threshold value in the first embodiment. The calculation unit 140 calculates a separation level by using the plurality of values. Specifically, the calculation unit 140 calculates the separation level by using expression (1).

$$separation level = inter ‐ class variance / intra ‐ class variance \qquad ( 1 )$$

The value when the separation level is at the maximum is determined as the class classification threshold value.

The calculation unit 140 classifies the plurality of values based on the class classification threshold value. In short, the calculation unit 140 makes a 2-class classification.

The calculation unit 140 calculates one value in regard to each class obtained by the classification. For example, the calculation unit 140 calculates a mean value or a representative value in regard to each class obtained by the classification. For example, when the mean value is calculated, the calculation unit 140 calculates the mean value of a first class by using a plurality of values belonging to the first class and calculates the mean value of a second class by using a plurality of values belonging to the second class.

The calculation unit 140 calculates a difference between the calculated two values as an inter-class distance. For example, the calculation unit 140 calculates the difference between the mean value of the first class and the mean value of the second class as the inter-class distance.

The determination unit 150 determines that the stranded wire is abnormal when the inter-class distance is greater than or equal to a predetermined threshold value. Incidentally, this threshold value is referred to also as a first threshold value. This threshold value is 0.7, for example.

The output unit 160 outputs a result. For example, the output unit 160 outputs the result to a display of the information processing device 100. Further, for example, the output unit 160 outputs the result to the external device. Incidentally, the result is the result of the determination, for example.

Next, a process executed by the information processing device 100 will be described below by using a flowchart.

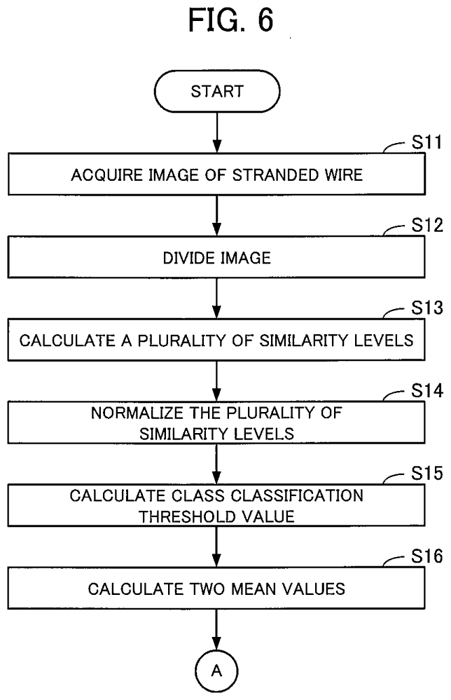

FIG. 6 is a flowchart showing an example (part 1) of the process executed by the information processing device in the first embodiment.

(Step S11) The acquisition unit 120 acquires an image of a stranded wire.

(Step S12) The division unit 130 divides the image of the stranded wire.

(Step S13) The calculation unit 140 calculates a plurality of similarity levels by using a plurality of object images set out of a plurality of images obtained by the division and a plurality of comparative images set out of the plurality of images.

(Step S14) The calculation unit 140 normalizes the plurality of similarity levels.

(Step S15) The calculation unit 140 calculates the class classification threshold value by using a plurality of values obtained by the normalization.

(Step S16) The calculation unit 140 calculates the mean value in regard to each class obtained by the classification of the plurality of values based on the class classification threshold value. Then, the process advances to step S21.

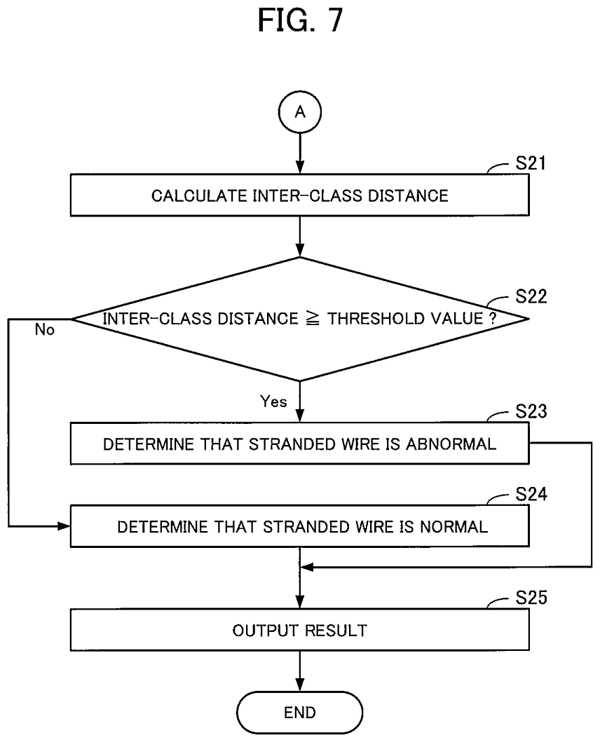

FIG. 7 is a flowchart showing the example (part 2) of the process executed by the information processing device in the first embodiment.

(Step S21) The calculation unit 140 calculates the difference between the two mean values as the inter-class distance.

(Step S22) The determination unit 150 determines whether or not the inter-class distance is greater than or equal to the predetermined threshold value. When the inter-class distance is greater than or equal to the threshold value, the process advances to step S23. When the inter-class distance is less than the threshold value, the process advances to step S24.

(Step S23) The determination unit 150 determines that the stranded wire is abnormal.

(Step S24) The determination unit 150 determines that the stranded wire is normal.

(Step S25) The output unit 160 outputs the result.

According to the first embodiment, the information processing device 100 is capable of detecting an abnormality with high accuracy by executing the above-described process. For example, even when the image of the stranded wire includes a lot of noise, the information processing device 100 is capable of detecting an abnormality with high accuracy by executing the above-described process. Further, even when there exists a small abnormal part in the stranded wire, the information processing device 100 is capable of detecting the abnormality with high accuracy by executing the above-described process. Accordingly, the information processing device 100 is capable of detecting an abnormality with high accuracy.

### Second Embodiment

Next, a second embodiment will be described below. In the second embodiment, the description will be given mainly of features different from those in the first embodiment. In the second embodiment, the description is omitted for features in common with the first embodiment.

In the first embodiment, the description has given of the case where whether the stranded wire is normal or not is determined. In the second embodiment, a description will be given of a case where an abnormal part is detected when the stranded wire is abnormal.

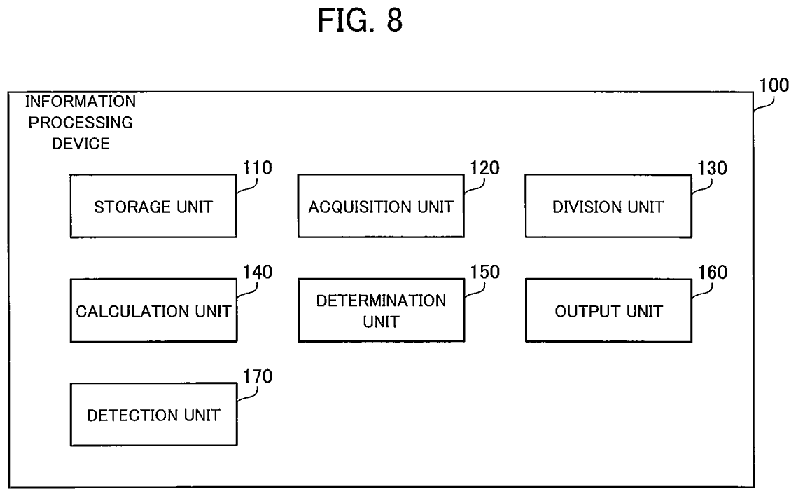

FIG. 8 is a block diagram showing functions of an information processing device in the second embodiment. The information processing device 100 further includes a detection unit 170. Part or the whole of the detection unit 170 may be implemented by processing circuitry. Further, part or the whole of the detection unit 170 may be implemented as modules of a program executed by the processor 101.

Details of the function of the detection unit 170 will be described later.

Next, a process executed by the information processing device 100 will be described below by using a flowchart.

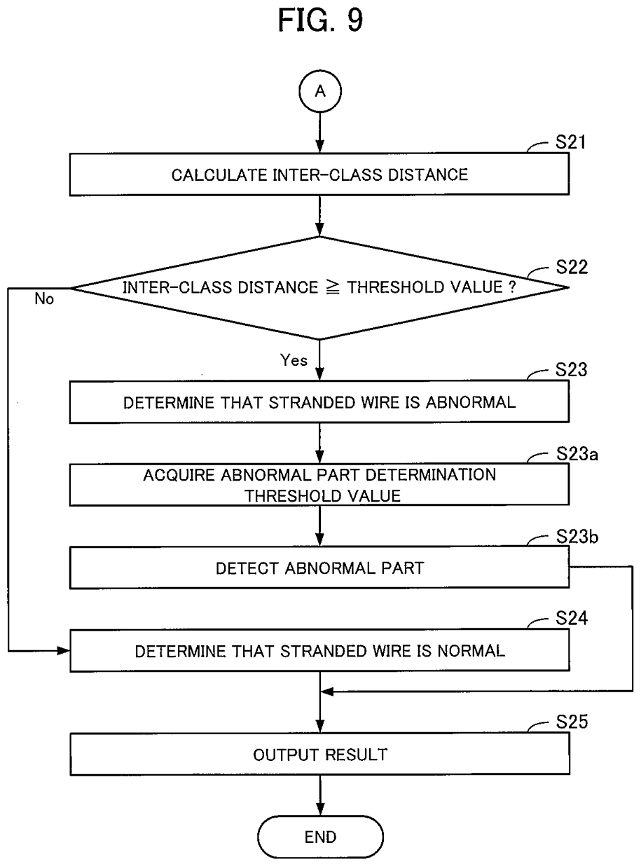

FIG. 9 is a flowchart showing an example of the process executed by the information processing device in the second embodiment. The process in FIG. 9 differs from the process in FIG. 7 in that steps S23a and S23b are executed. Thus, the steps S23a and S23b in FIG. 9 will be described below. Then, the description will be omitted for processing other than the steps S23a and S23b.

(Step S23a) The acquisition unit 120 acquires an abnormal part determination threshold value. The abnormal part determination threshold value is referred to also as a second threshold value.

The process of acquiring the abnormal part determination threshold value will be described below. The abnormal part determination threshold value can be a predetermined value. When the abnormal part determination threshold value is a predetermined value, the acquisition unit 120 acquires the abnormal part determination threshold value from the storage unit 110 or the external device. Alternatively, the calculation unit 140 may calculate the abnormal part determination threshold value. For example, the calculation unit 140 calculates the abnormal part determination threshold value by using expression (2).

$$abnormal part determination threshold value = class classification threshold value \times 2 \qquad ( 2 )$$

Further, the calculation unit 140 may also multiply the class classification threshold value by a value other than “2”. Upon the calculation of the abnormal part determination threshold value by the calculation unit 140, the acquisition unit 120 acquires the calculated abnormal part determination threshold value.

(Step S23b) The detection unit 170 detects a value greater than or equal to the abnormal part determination threshold value among the plurality of values obtained by the normalization. The detection unit 170 detects a part indicated by the image corresponding to the detected value as an abnormal part.

The abnormal part detection process will be described below by using FIG. 3. The detected value is assumed to be the value obtained by normalizing the similarity level corresponding to the image 12. The detection unit 170 detects a part indicated by the image 12 corresponding to the detected value as the abnormal part.

According to the second embodiment, the information processing device 100 is capable of detecting an abnormal part.

### Third Embodiment

Next, a third embodiment will be described below. In the third embodiment, the description will be given mainly of features different from those in the first or second embodiment. In the third embodiment, the description is omitted for features in common with the first or second embodiment.

A process executed by an information processing device 100 in the third embodiment will be briefly described below.

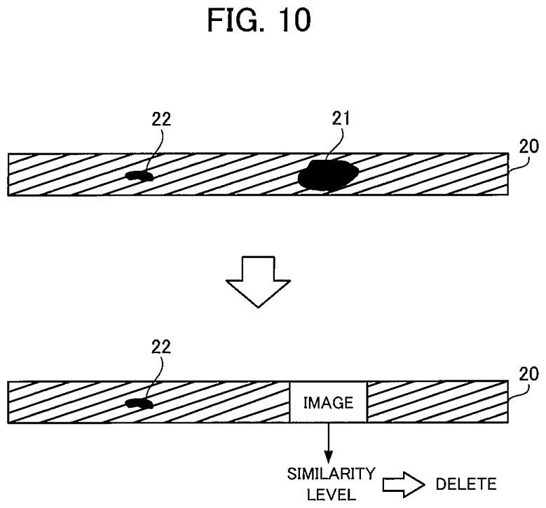

FIG. 10 is a diagram showing a general outline of the process executed by the information processing device in the third embodiment. FIG. 10 shows an image 20 of a stranded wire. The image 20 indicates an abnormal part 21 and an abnormal part 22.

In the method in the second embodiment, there are cases where an abnormal part not detected in one detection process exists. For example, the abnormal part 21 is detected, whereas the abnormal part 22 is not detected. Therefore, the information processing device 100 deletes a similarity level corresponding to an image including the abnormal part 21. Then, the information processing device 100 executes the abnormal part detection process again. By this method, the information processing device 100 is capable of detecting the abnormal part 22.

Next, the process executed by the information processing device 100 will be described below by using a flowchart.

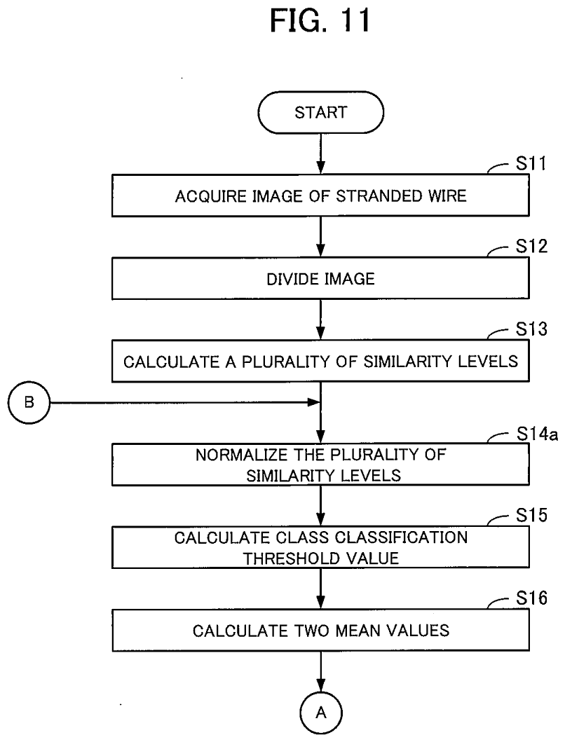

FIG. 11 is a flowchart showing an example (part 1) of the process executed by the information processing device in the third embodiment. The process in FIG. 11 differs from the process in FIG. 6 in that step S14a is executed. Thus, the step S14a in FIG. 11 will be described below. Then, the description will be omitted for processing other than the step S14a.

(Step S14a) The calculation unit 140 normalizes the plurality of similarity levels. Further, when the step S14a is executed after step S23d, the similarity level corresponding to the image including the abnormal part is excluded from the plurality of similarity levels.

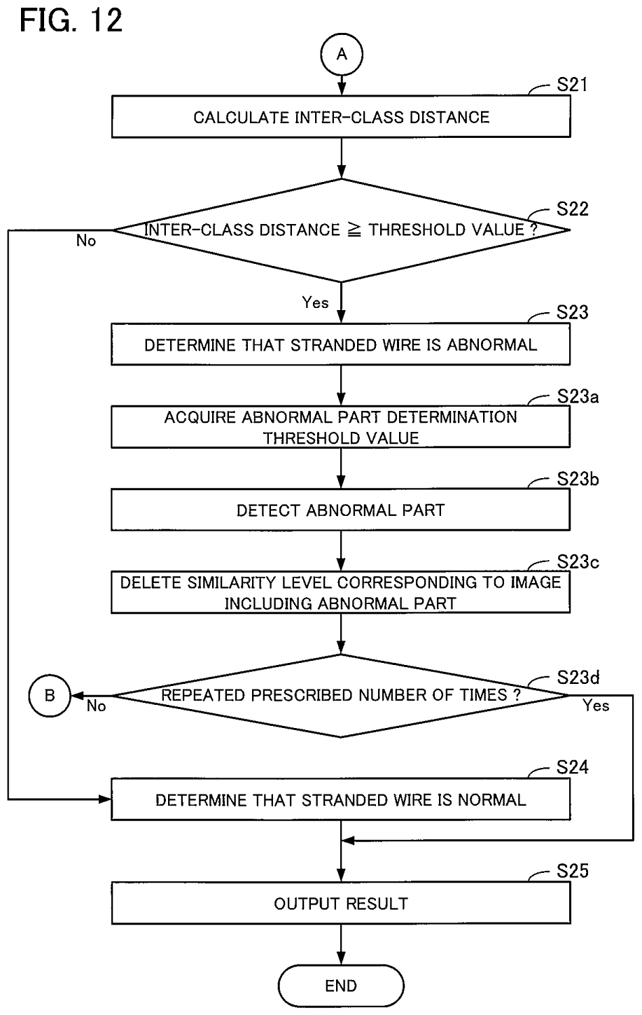

FIG. 12 is a flowchart showing the example (part 2) of the process executed by the information processing device in the third embodiment. The process in FIG. 12 differs from the process in FIG. 9 in that steps S23c and S23d are executed. Thus, the steps S23c and S23d in FIG. 12 will be described below. Then, the description will be omitted for processing other than the steps S23c and S23d. However, when the step S23a is repeated, the acquisition unit 120 acquires the abnormal part determination threshold value calculated based on the class classification threshold value.

(Step S23c) The detection unit 170 deletes the similarity level corresponding to the image including the abnormal part.

(Step S23d) The detection unit 170 judges whether or not the preceding processing has been repeated a prescribed number of times. When the preceding processing has been repeated the prescribed number of times, the process advances to step S25. When the preceding processing has not been repeated the prescribed number of times, the process advances to the step S14a.

Incidentally, in the step S23c, the detection unit 170 does not necessarily have to delete the similarity level corresponding to the image including the abnormal part. In the case where the similarity level is not deleted, the calculation unit 140 in the step S14a performs the normalization by excluding the similarity level corresponding to the image including the abnormal part from the plurality of similarity levels.

As above, in the case where the detection process for detecting another abnormal part is executed and a plurality of similarity levels are normalized after an abnormal part is detected, the similarity level corresponding to the image including the abnormal part is excluded from the plurality of similarity levels.

According to the third embodiment, the information processing device 100 is capable of detecting a small abnormal part even when a large abnormal part exists in the vicinity.

### Fourth Embodiment

Next, a fourth embodiment will be described below. In the fourth embodiment, the description will be given mainly of features different from those in the first or second embodiment. In the fourth embodiment, the description is omitted for features in common with the first or second embodiment.

A stranded wire can have a metal fixture or the like attached thereto. In the method in the second embodiment, there is a possibility that a part to which a metal fixture or the like has been attached is erroneously determined as an abnormal part. Further, in the method in the second embodiment, there is, for example, a possibility that a part on which a shadow of another stranded wire exists is erroneously determined as an abnormal part. As above, there is a possibility that a normal part is erroneously determined as an abnormal part. Therefore, in the fourth embodiment, a description will be given of a case where a normal part is prevented from being erroneously detected as an abnormal part.

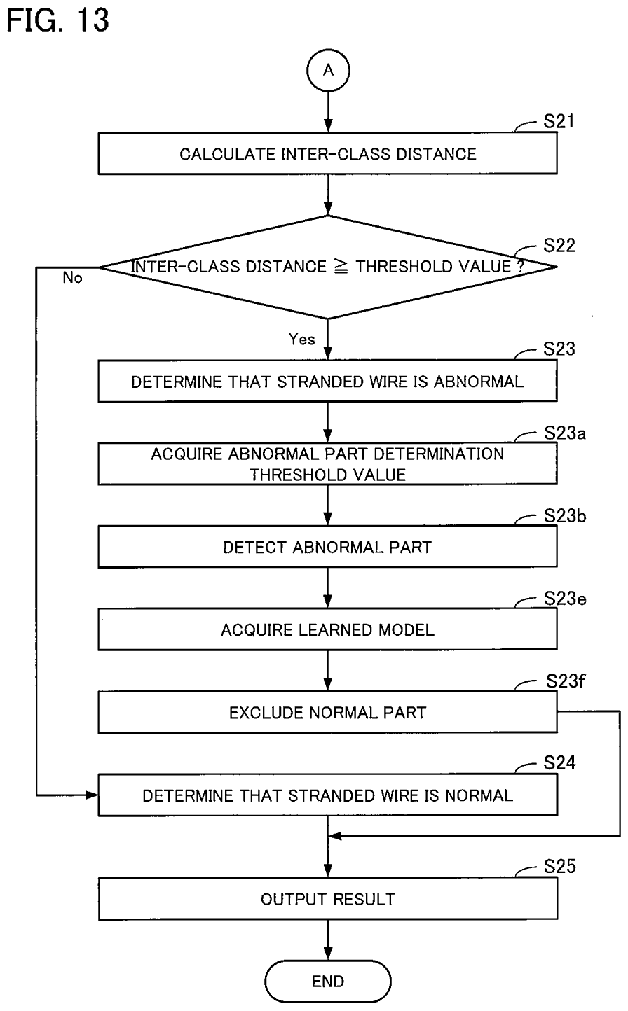

FIG. 13 is a flowchart showing an example of a process executed by an information processing device in the fourth embodiment. The process in FIG. 13 differs from the process in FIG. 9 in that steps S23e and S23f are executed. Thus, the steps S23e and S23f in FIG. 13 will be described below. Then, the description will be omitted for processing other than the steps S23e and S23f. The abnormal part detected in the step S23b may be regarded as a provisionally detected abnormal part.

(Step S23e) The acquisition unit 120 acquires a learned model. For example, the acquisition unit 120 acquires the learned model from the storage unit 110 or the external device. Incidentally, the learned model is generated by using images each including a normal part (e.g., metal fixture) as learning data.

(Step S23f) By using the image including the abnormal part and the learned model, the detection unit 170 judges whether the abnormal part is an abnormal part or not. In other words, by using the image including the provisionally detected abnormal part and the learned model, the detection unit 170 judges whether the provisionally detected abnormal part is an abnormal part or not. Specifically, when the detection unit 170 inputs the image including the abnormal part to the learned model, the learned model outputs information indicating whether the part indicated by the inputted image is an abnormal part or not. When the part indicated by the inputted image is not an abnormal part (that is, when the part indicated by the inputted image is a normal part), the detection unit 170 detects the part indicated by the inputted image as a normal part.

Further, when a plurality of abnormal parts has been detected, the detection unit 170 judges whether a part indicated by each of a plurality of images is an abnormal part or not by using the plurality of images and the learned model. The detection unit 170 excludes normal parts from the plurality of detected abnormal parts. Accordingly, when a plurality of abnormal parts is detected in the step S23b, the result excluding the normal parts is outputted in the step S25. In other words, only originally abnormal parts are outputted as the result.

According to the fourth embodiment, the information processing device 100 is capable of preventing a normal part from being erroneously detected as an abnormal part. Further, there are cases where components or the like that are desired to be excluded as normal parts increase. In such cases, the learned model is relearned by using images including components or the like that are desired to be excluded. Then, the information processing device 100 is capable of even dealing with such a situation where components or the like desired to be excluded have increased by using the relearned learned model.

### Modification of Fourth Embodiment

Next, a modification of the fourth embodiment will be described below. In the modification of the fourth embodiment, a case where the third embodiment and the fourth embodiment are combined together will be described.

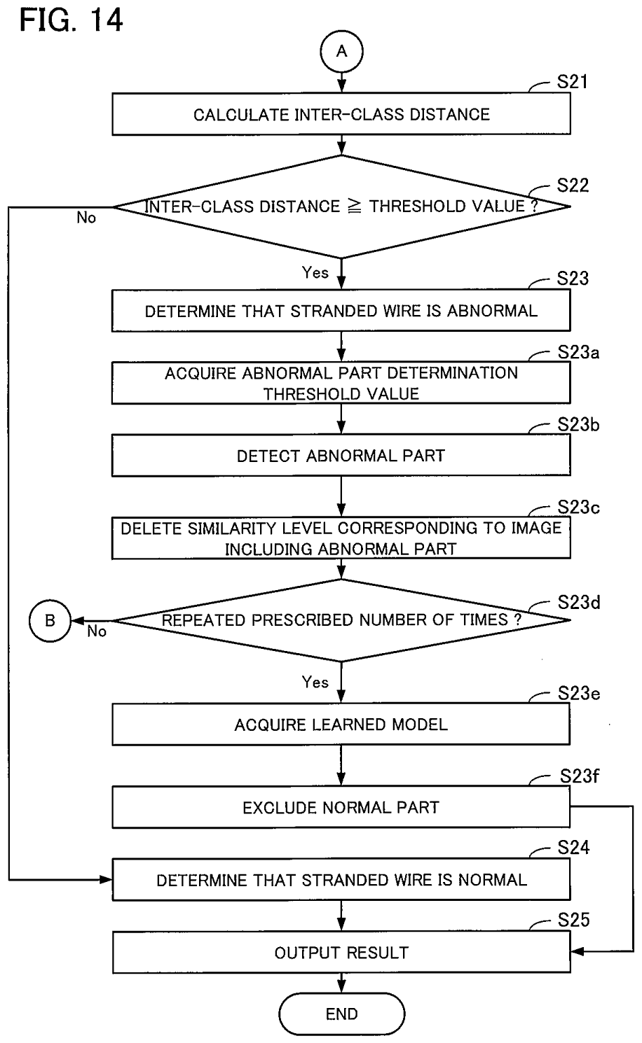

FIG. 14 is a flowchart showing an example of a process executed by an information processing device in the modification of the fourth embodiment. The process in FIG. 14 differs from the process in FIG. 12 in that the steps S23e and S23f are executed. The processing in the steps S23e and S23f is the same as the processing described above. Thus, the description of the processing in the steps S23e and S23f is left out.

According to the modification of the fourth embodiment, the information processing device 100 is capable of preventing a normal part from being erroneously detected as an abnormal part.

Features in the embodiments described above can be appropriately combined with each other.

### DESCRIPTION OF REFERENCE CHARACTERS

10: image, 11: image, 12: image, 13: image, 14: image, 20: image, 21: abnormal part, 22: abnormal part, 100: information processing device, 101: processor, 102: volatile storage device, 103: nonvolatile storage device, 110: storage unit, 120: acquisition unit, 130: division unit, 140: calculation unit, 150: determination unit, 160: output unit, 170: detection unit

What is claimed is:

1. An information processing device comprising:
acquiring circuitry to acquire an image of a stranded wire;
dividing circuitry to divide the image of the stranded wire;
calculating circuitry to calculate a plurality of similarity levels by using a plurality of object images set out of a plurality of images obtained by the division and a plurality of comparative images set out of the plurality of images, normalize the plurality of similarity levels, calculate a class classification threshold value by using a plurality of values obtained by the normalization, calculate one value in regard to each class obtained by classification of the plurality of values based on the class classification threshold value, and calculate a difference between the calculated two values as an inter-class distance; and
determining circuitry to determine that the stranded wire is abnormal when the inter-class distance is greater than or equal to a predetermined first threshold value.

2. The information processing device according to claim 1, wherein the determining circuitry determines that the stranded wire is normal when the inter-class distance is less than the first threshold value.

3. The information processing device according to claim 1, further comprising detecting circuitry, wherein
the acquiring circuitry acquires a second threshold value, and
the detecting circuitry detects a value greater than or equal to the second threshold value among the plurality of values obtained by the normalization and detects a part indicated by the image corresponding to the detected value as an abnormal part.

4. The information processing device according to claim 3, wherein
when a detection process for detecting another abnormal part is executed and the plurality of similarity levels are normalized after an abnormal part is detected, the similarity level corresponding to the image including the abnormal part is excluded from the plurality of similarity levels, and
when the detection process for detecting another abnormal part is executed, the acquiring circuitry acquires the second threshold value calculated based on the class classification threshold value.

5. The information processing device according to claim 3, wherein
the acquiring circuitry acquires a learned model, and
by using the image including the abnormal part and the learned model, the detecting circuitry judges whether the part indicated by the image is the abnormal part or not, and when the part indicated by the image is not an abnormal part, detects the part indicated by the image as a normal part.

6. The information processing device according to claim 1, further comprising outputting circuitry to output a result.

7. A detection method performed by an information processing device, the detection method comprising:
acquiring an image of a stranded wire;
dividing the image of the stranded wire;
calculating a plurality of similarity levels by using a plurality of object images set out of a plurality of images obtained by the division and a plurality of comparative images set out of the plurality of images;
normalizing the plurality of similarity levels;
calculating a class classification threshold value by using a plurality of values obtained by the normalization;
calculating one value in regard to each class obtained by classification of the plurality of values based on the class classification threshold value;
calculating a difference between the calculated two values as an inter-class distance; and
determining that the stranded wire is abnormal when the inter-class distance is greater than or equal to a predetermined first threshold value.

8. An information processing device comprising:
a processor to execute a program; and
a memory to store the program which, when executed by the processor, performs processes of,
acquiring an image of a stranded wire,
dividing the image of the stranded wire,
calculating a plurality of similarity levels by using a plurality of object images set out of a plurality of images obtained by the division and a plurality of comparative images set out of the plurality of images,
normalizing the plurality of similarity levels,
calculating a class classification threshold value by using a plurality of values obtained by the normalization,
calculating one value in regard to each class obtained by classification of the plurality of values based on the class classification threshold value,
calculating a difference between the calculated two values as an inter-class distance, and
determining that the stranded wire is abnormal when the inter-class distance is greater than or equal to a predetermined first threshold value.
